(19) United States
(12) Patent Application Publication
(10) Pub. No.: US 2021/0329285 A1
(43) Pub. Date: Oct. 21, 2021

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Keiko Yonezawa, Kanagawa (JP)

(21) Appl. No.: 17/230,785

(22) Filed: Apr. 14, 2021

(30) Foreign Application Priority Data
Apr. 21, 2020 (JP) 2020-075607

(51) Int. Cl. H04N 19/51; H04N 19/124; H04N 19/23; H04N 19/573

(52) U.S. Cl. CPC H04N 19/51; H04N 19/573; H04N 19/23; H04N 19/124

(57) ABSTRACT

An image processing apparatus comprises a determination unit configured to obtain a pixel value of the same pixel position from a plurality of images and determine, based on a frequency distribution of the obtained pixel value, the pixel value and an amount of movement in the pixel position in a background image, and a setting unit configured to set a compression coding parameter to the background image. In a specific region in the background image, the setting unit sets a compression coding parameter corresponding to an amount of movement of a pixel belonging to the specific region.

### BACKGROUND

### Field of the Disclosure

The present disclosure relates to an image compression coding technique.

### Description of the Related Art

In recent years, along with the proliferation of smartphones, digital video cameras, and the like, opportunities for generating video data by performing image capturing have increased. On the other hand, since the storage capacity for storing data and the communication band used for exchanging data are limited, there is a need for a technique that can efficiently compress video data. As a video compression method, H.264/AVC is known as a standard. In addition, H.265/HEVC has also become popular as a standard.

In a video data compression coding technique, parameters such as a quantization parameter and the like are defined for the adjustment of image quality. By using these parameters, the data amount needs to be minimized as much as possible while maintaining necessary information. More specifically, there is a method in which a region of interest in a video is extracted as an ROI (Region of Interest), and different quantization parameters are used for the ROI and each region other than the ROI. Since a moving object tends to be an object of importance in the case of a network camera which is used mainly for the purpose of monitoring, a method that detects a moving object and sets the detected moving object as an ROI is known. In addition, a method that detects a specific object, such as a person, a car, or the like that tends to be regarded as more important among moving objects, and specifies only the specific object as an ROI is also generally used,

Although moving objects tend to be objects of importance, there can be exceptions. For example, moving objects can be background objects which constantly sway such as a fountain, the sea surface, trees which are being blown by the wind, and the like. Since such background objects move in a complicated manner, an accurate reproduction of these objects can degrade the compression efficiency and increase the data amount. However, the information included as these objects are generally unimportant. Hence, by increasing the image quality of an important region as an ROI while simultaneously decreasing the image quality of an unimportant region which has movement, it will be possible to reduce the bit rate without the loss of important information.

A region such as a water surface, vegetation, or the like can be obtained by applying a region-based segmentation (also referred to as segmentation) method on every single image (to be referred to as a frame) forming an obtained video. However, since the regions cannot be correctly segmented if a person or a car which is to be the foreground is included, a background image needs to be generated by excluding the foreground. Japanese Patent Laid-Open No. 2012-203680 discloses a method of generating a background image by using a plurality of frames. In addition, Japanese Patent Laid-Open No. 8-181992 discloses a method that changes the image quality by segmenting a human facial region, which is regarded to be an important region, into a region with movement and a region without movement.

Although the method of Japanese Patent Laid-Open No. 2012-203680 can be used to create a background image that excludes the foreground, the method of Japanese Patent Laid-Open No. 2012-203680 does not perform compression control by using the background image. Since a region with movement included in the background is not targeted in the method of Japanese Patent Laid-Open No. 8-181992, the movement of vegetation or the like is not assumed in the method. Furthermore, although region-based segmentation can be performed for each frame and the image quality parameter can be changed depending on the segmented contents, the image quality will be set uniformly for the vegetation in such a case and the image quality settings cannot be changed between vegetation which is moving and vegetation which is not moving.

### SUMMARY

The present disclosure provides, in a case in which different compression coding parameters are to be set for a specific region and a non-specific region of a background image used in compression coding, a technique for setting a compression coding parameter that corresponds to an amount of movement in the specific region.

In order to set, in a case in which different compression coding parameters are to be set for a specific region and a non-specific region of a background image used in compression coding, a compression coding parameter that corresponds to an amount of movement in the specific region, a first aspect of the present disclosure provides an image processing apparatus comprising: a determination unit configured to obtain a pixel value of the same pixel position from a plurality of images and determine, based on a frequency distribution of the obtained pixel value, the pixel value and an amount of movement in the pixel position in a background image; and a setting unit configured to set a compression coding parameter to the background image, wherein in a specific region in the background image, the setting unit sets a compression coding parameter corresponding to an amount of movement of a pixel belonging to the specific region.

A second aspect of the present disclosure provides an image processing method performed by an image processing apparatus, comprising: obtaining a pixel value of the same pixel position from a plurality of images, and determining, based on a frequency distribution of the obtained pixel value, the pixel value and an amount of movement in the pixel position in a background image; and setting a compression coding parameter to the background image, wherein in a specific region in the background image, a compression coding parameter corresponding to an amount of movement of a pixel belonging to the specific region is set in the setting.

Further features of the present disclosure will become apparent from the following description of exemplary embodiments with reference to the attached drawings.

### BRIEF DESCRIPTION OF THE DRAWINGS

FIG. 1 is a block diagram showing an example of the arrangement of an image processing system;

FIG. 2A is a block diagram showing an example of the functional arrangement of an image processing apparatus;

FIG. 2B is a block diagram showing an example of the hardware arrangement of the image processing apparatus;

FIG. 3 is a view for explaining a use case of the first embodiment;

FIG. 4 is a flowchart of processing performed in an analysis stage by the image processing apparatus;

FIGS. 5A and 5B are graphs showing examples of histograms;

FIG. 6 is a view showing an example of a background image generated from images capturing the scene of FIG. 3;

FIG. 7 is a flowchart of processing performed in a compression stage by the image processing apparatus;

FIG. 8 is a flowchart of processing performed in an analysis stage by an image processing apparatus; and

FIG. 9 is a flowchart of processing performed in a compression stage by the image processing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Each of the following embodiments will describe an example in which image capturing is performed for the purpose of monitoring. However, the present disclosure is not limited to this, and each of the following embodiments is applicable to image capturing performed for various kinds of purposes such as for the purpose of broadcasting and the like. In addition, each of the following embodiments will describe an image processing apparatus that functions as an image capturing apparatus (network camera) that can connect to a network to communicate with another apparatus. However, the present disclosure is not limited to this, and each of the following embodiments can be applied to an image processing apparatus that functions as an image capturing apparatus that is capable of connecting to a network. Furthermore, although the image processing apparatus will be described as having an image capturing function in each of the following embodiments, the present disclosure is not limited to an example in which the image processing apparatus has the image capturing function. The image capturing function may be implemented by an apparatus separate from the image processing apparatus, and the image processing apparatus may be configured to obtain a captured image from this separate apparatus.

### First Embodiment

This embodiment includes an analysis stage in which a background image that is to be used for compressing (compression-coding) an image of a frame in a captured moving image is analyzed, and a compression stage in which an image of a frame in a moving image captured after the analysis stage is compression-coded by using the result of the analysis.

In the preceding analysis stage, a background image and an amount of movement in a given time for each pixel position in the background image are obtained from the respective images of a plurality of frames of a moving image capturing the same seen by a fixed angle of view or the like. Subsequently, different compression coding parameters are set for a specific region and a non-specific region in the background image. A compression coding parameter that corresponds to the amount of movement in the specific region will be set for the specific region. Although an example that uses, as the compression coding parameter, a Qp value which is a quantization parameter value will be described hereinafter, the compression coding parameter is not limited to the Qp value. Any kind of compression coding parameter can be employed as long as it is a compression coding parameter that influences the image quality.

In the subsequent compression stage, a foreground is extracted from an image of each frame in the moving image capturing the same scene (the same scene as the scene captured in the analysis stage) by a fixed angle of view or the like, and an ROI is set to the extracted foreground. Subsequently, “a Qp value set to the specific region of the background image” is set to a correspondence region that corresponds to the above-described specific region in the image, and “a Qp value set to a non-specific region of the background image” is set to a correspondence region that corresponds to the above-described non-specific region in the image, At this time, “a Qp value corresponding to high image quality (a Qp value which is smaller than either of the Qp value of the specific region and the Qp value of the non-specific region)” will be set to the ROI of the image. Subsequently, by executing compression coding by quantifying each region of the image by using the Qp value of the region, image compression can be performed so that only the image quality of a region that has a large movement in the background but does not include important information in contrast to the high compression cost will be decreased while maintaining the image quality of an important region in the foreground.

### Example of Arrangement of Image Processing System 10

First, an example of the arrangement of the image processing system 10 according to this embodiment will be described with reference to the block diagram of FIG. 1. As shown in FIG. 1, the image processing system 10 according to this embodiment includes an image processing apparatus 100 and a client apparatus 200, and these apparatuses are configured to be capable of executing data communication with each other via a network 300. Although the image processing apparatus 100 is assumed to be an apparatus (a network camera or the like) that can communicate with another apparatus by connecting to the network 300 in this embodiment, the apparatus need not be able to connect to the network 300.

Based on an operation by a user. the client apparatus 200 transmits, to the image processing apparatus 100, a distribution request command for requesting the distribution of a moving image (stream) and a setting command for setting various kinds of parameters, information of the ROI, and the like. The image processing apparatus 100 will transmit a stream to the client apparatus 200 in response to the distribution request command, and store the various kinds of parameters, the information of the ROI, and the like in response to the setting command. The client apparatus 200 is a computer apparatus such as a personal computer, a tablet terminal, a smartphone, or the like. A processor of a CPU or the like of the client apparatus 200 will use computer programs and data stored in a memory of the client apparatus 200 to execute various kinds of processing. As a result, the processor of the client apparatus 200 can control the operation of the entire client apparatus 200 as well as execute or control each processing operation to be described as processing to be executed by the client apparatus 200.

### Example of Arrangement of Image Processing Apparatus 100

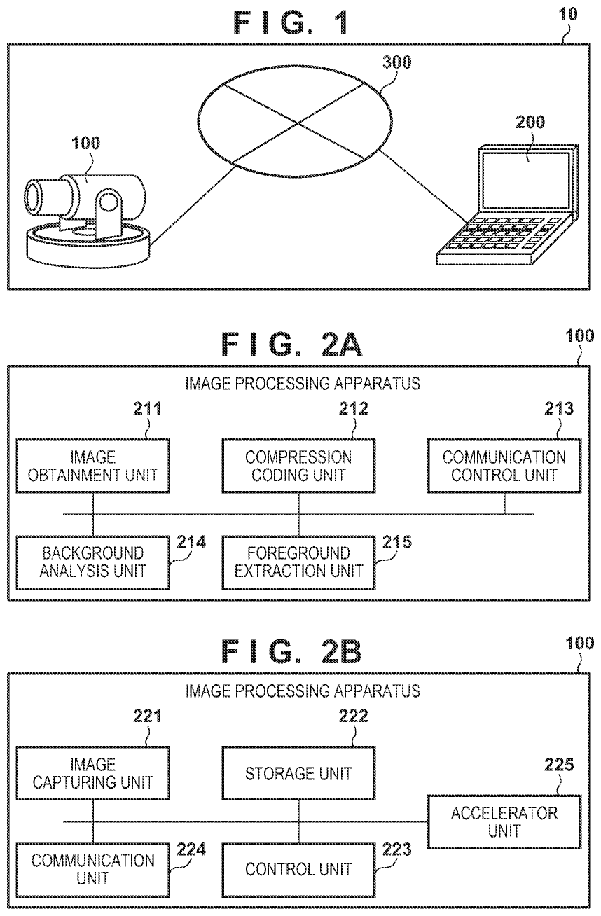

An example of the arrangement of the image processing apparatus 100 will be described with reference to FIGS. 2A and 2B. FIG. 2A is a block diagram showing an example of the functional arrangement of the image processing apparatus 100. FIG. 2B is a block diagram showing an example of the hardware arrangement of the image processing apparatus 100.

The example of the functional arrangement of the image processing apparatus 100 will be described first with reference to the block diagram of FIG. 2A. An image obtainment unit 211 obtains a moving image from an image capturing unit 221 (FIG. 2B), an external device (not shown), or the like, and obtains a captured image (image frame) of each frame from the moving image. For example, the image obtainment unit 211 uses the various kinds of parameters (various kinds of settings) obtained from a storage unit 222 (FIG. 2B) to generate a captured image (image frame) of each frame from the moving image.

A background analysis unit 214 uses the captured images, of a plurality of frames, obtained by the image obtainment unit 211 to generate a background image from which the foreground of the captured scene has been excluded and to obtain an amount of movement corresponding to each pixel in the background image. Next, although the background analysis unit 214 will execute region-based segmentation so the generated background image will be segmented into regions for respective objects and set a Qp value for each segmented region, a Qp value corresponding to a corresponding amount of movement will be set for a segmented region of a specific object. Subsequently, the background analysis unit 214 stores the Qp values set for the respective regions in the storage unit 222.

A foreground extraction unit 215 extracts the foreground (foreground region) from each captured image obtained by the image obtainment unit 211, and sets an ROI to each extracted foreground. A compression coding unit 212 uses the Qp values stored in the storage unit 222 by the background analysis unit 214 to perform compression coding of each captured image obtained as a compression coding target by the image obtainment unit 211.

A compression coding unit 213 transmits, for example, in a streaming format via a communication unit 224 (FIG. 2B), each captured image that has been compression-coded by the compression coding unit 212 to the client apparatus 200 through the network 300. The format and the transmission destination of the data transmitted by the compression coding unit 213 are not limited to a specific data format and a specific transmission destination.

Next, an example of the hardware arrangement of the image processing apparatus 100 will be described with reference to FIG. 2B. The image capturing unit 221 obtains a moving image by using an image capturing element to receive the light of an image formed through a lens and converting the received light into electrical charges. For example, a CMOS (Complementary Metal Oxide Semiconductor) image sensor can be used as the image capturing element. A CCD (Charge Coupled Device) image sensor may also be used as the image capturing element.

The storage unit 222 includes memory devices such as a ROM (Read Only Memory), a RAM (Random Access Memory), and the like. The storage unit 222 stores the computer programs and data to be used by a control unit 223 to execute or control various kinds of processing which are described as processing performed by the image processing apparatus 100. In addition, the storage unit 222 can store data (commands and images) and various kinds of parameters obtained via the communication unit 224 from an external device such as the client apparatus 200 or the like. For example, the storage unit 222 stores camera parameters such as the settings of white balance, exposure, and the like of the moving image obtained by the image capturing unit 221, the compression coding parameters, and the like. Quantization parameter values (Qp values) are included in the compression coding parameters. Note that the quantization step will increase as the value of the Qp value increases and will decrease as the value of the Qp value decreases. Hence, the image quality will degrade as the Qp value used to perform the compression coding increases, and the image quality will improve as the Qp value used in the compression coding decreases. In addition, the storage unit 222 can store parameters related to each captured image such as the frame rate of the moving image, the size (resolution) of the captured image, and the like.

In addition, the storage unit 222 can provide a work area to be used when the control unit 223 is to execute various kinds of processing. Furthermore, the storage unit 222 can function as a frame memory and a buffer memory. Note that other than memories like the ROM, the RAM, and the like, a storage medium such as a flexible disk, a hard disk, an optical disk, a magnetooptical disk, a CD-ROM, a CD-R, a magnetic tape, a nonvolatile memory card, a DVD or the like can be used as the storage unit 222.

The control unit 223 includes a CPU (Central Processing Unit), an MPU (Micro Processing Unit), and the like. The control unit 223 executes various kinds of processing by using computer programs and data stored in the storage unit 222. As a result, in addition to controlling the operation of the entire image processing apparatus 100, the control unit 223 executes or controls each processing described to be performed by the image processing apparatus 100. Note that the control unit 223 may control the entire image processing apparatus 100 based on the cooperation of an OS (Operating System) and the computer programs stored in the storage unit 222. Note that the control unit 223 may be formed by a processor such as a DSP (Digital Signal Processor) or the like or an ASIC (Application Specific Integrated Circuit).

The communication unit 224 transmits/receives wired signals or wireless signals to communicate with the client apparatus 200 via the network 300. Note that each functional unit of the image processing apparatus 100 shown in FIG. 2A may be implemented by hardware or software (computer program). In the case of the latter, each computer program is stored in the above-described storage unit 222 and is executed by the control unit 223.

An accelerator unit 225 includes a CPU, a GPU (Graphics Processing Unit), an FPGA (Field-Programmable Gate Array), a storage unit, and the like. The accelerator unit 225 is a processing unit added to the image capturing unit 221 to mainly execute high performance processing by deep learning. The accelerator unit 225 may also perform the processing operations of the background analysis unit 214 and the foreground extraction unit 215.

The processing operations of the functional units shown in FIG. 2A will be mainly described hereinafter. Note that if each functional unit shown in FIG. 2A is to be implemented by software (computer program), the function of the functional unit will be implemented by causing the control unit 223 to execute a computer program for causing the control unit 223 to execute or control the function of the functional unit. In addition, the accelerator unit 225 may perform processing to execute high-speed processing by machine learning.

### Analysis Stage Processing

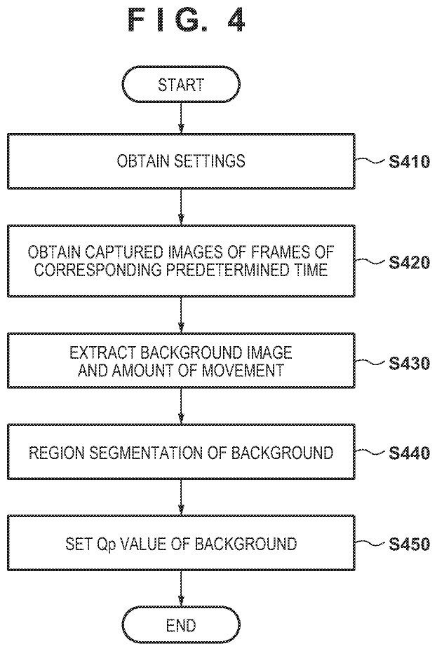

The processing performed by the image processing apparatus 100 in the analysis stage will be described in accordance with the flowchart of FIG. 4. In step S410, the image obtainment unit 211 obtains settings necessary for analyzing a moving image. For example, the image obtainment unit 211 obtains parameters related to the moving image, camera parameters, and the like from the storage unit 222. The parameters related to the moving image include the frame rate of the moving image and the size (resolution) of the moving image, and the camera parameters include the settings of the white balance, the exposure, the camera gain, and the like of the image capturing unit 221. As one example, assume that the size of the moving image is 1,280 (pixels)×720 (pixels), and the frame rate is 30 fps in this embodiment.

In addition, the image obtainment unit 211 obtains compression coding parameters from the storage unit 222. The compression coding parameters obtained by the image obtainment unit 211 from the storage unit 222 include the respective Qp values (quantization parameter values), described above, for executing compression coding in compliance with H.264. The Qp values to be obtained by the image obtainment unit 211 include a Qp value (Qp value of a non-specific region) for the general background and a Qp value of a specific region. As one example, assume that the Qp value of the general background is “36” and the Qp value of the specific region is “40”.

In step S420, the image obtainment unit 211 generates, from the moving image captured by the image capturing unit 221, captured images consisting of frames of a corresponding predetermined time in accordance with the various kinds of settings obtained in step S410. In this embodiment, in a case in which the predetermined time is, for example, 10 minutes and the frame rate is 30 fps, 18,000 frames of captured images will be generated from the moving image.

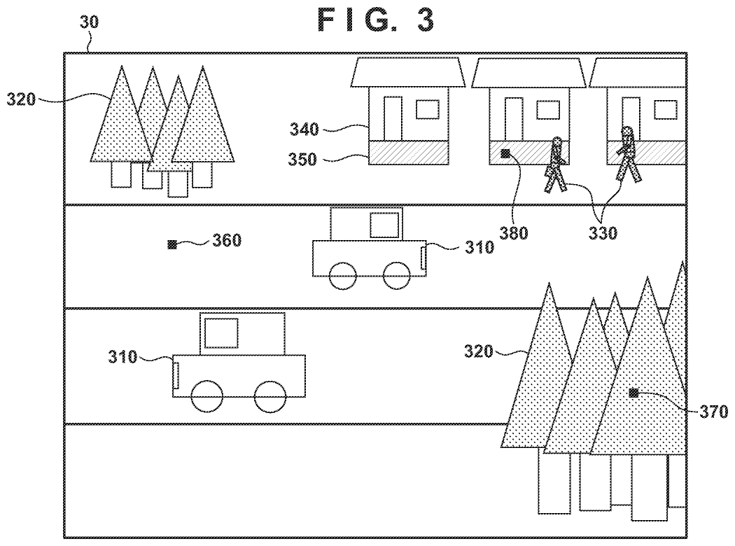

This embodiment assumes a use case targeting monitoring of a general road as shown in FIG. 3. A captured image 30 shown in FIG. 3 includes cars 310 traveling rightward and leftward on the road, trees 320 in the periphery of the road, people 330 walking on a sidewalk, buildings 340, a lawn 350 in front of each of the buildings 340, and the like.

In step S430, the background analysis unit 214 uses the 18,000 captured images obtained by the image obtainment unit 211 in step S420 to obtain a background image and an amount of movement for each small region in the background image.

The generation method of the background image will be described first. The background image is generated by combining, for each small region, the most frequent pixel value of each correspondence region of the 18,000 captured images, corresponding to the small region. A case in which each small region is a pixel and the pixel value is a luminance value will be described below. That is, a determination method for determining the luminance value of each pixel position (x, y) in the background image from the 18,000 captured images will be described below. Applying this determination method to each pixel position in the background image will determine the luminance value of each pixel position in the background image, and a background image in which the luminance values of the respective pixel positions have been determined can be generated as a result. First, the background analysis unit 214 will collect the luminance value of a pixel position (x, y) from each of the 18,000 captured images, and generate a frequency distribution of the collected luminance values (the luminance values of the 18,000 pixels). In this embodiment, as one example of the luminance distribution, the background analysis unit 214 will generate a histogram representing the frequency of each luminance value.

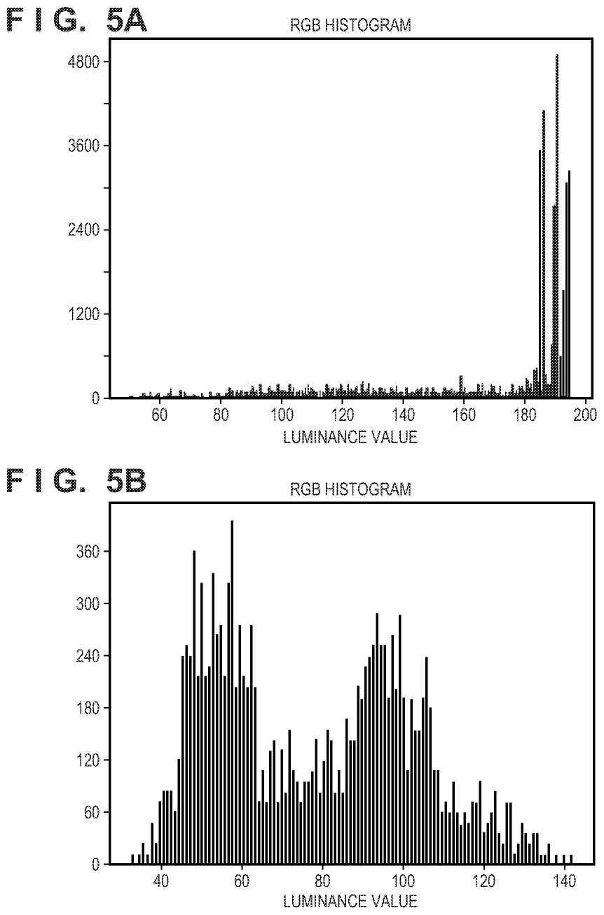

FIGS. 5A and 5B each show an example of a histogram. In each of FIGS. 5A and 5B, the abscissa represents the respective luminance values of R, G, and B values, and the ordinate represents the frequencies of the respective luminance values of the R, G, and B values.

FIG. 5A shows a histogram of the luminance values of the R, G, and B values collected from the pixel position (x, y) in each of the 18,000 captured images when a pixel position 360 (a pixel position in a region of the road) on the captured image 30 shown in FIG. 3 has been set as (x, y). Since the region of the road will have different luminance values only when a car passes, and the luminance will hardly change otherwise in this region. As a result, as shown in FIG. 5A, a histogram in which a frequency value that falls in a high frequency range will have a comparatively small variation and a frequency value that falls outside of the high frequency range will have a large variation is obtained. A state in which “a frequency value that falls outside of the high frequency range” corresponds to a state in which cars of various colors pass through the road. That is, “the amount of movement is small” in a predetermined time in the case of the pixel position 360 of FIG. 5A.

FIG. 5B shows a histogram of the luminance values of the R, G, and B values collected from the pixel position (x, y) in each of the 18,000 captured images when a pixel position 370 (a pixel position in a region of the trees) on the captured image 30 shown in FIG. 3 has been set as (x, y). Since the region of the trees is a region of a tree that is swayed greatly by a wind, the luminance will change greatly, and the variation of the frequency value will be, as a result, comparatively large in the histogram as shown in FIG. 5B. That is, “the amount of movement is large” in a predetermined time in the case of the pixel position 370 of FIG. 5B.

Hence, the background analysis unit 214 determines the highest frequency luminance value in the histogram generated for each pixel position (x, y) in the background image as the luminance value of the pixel at the pixel position (x, y) in the background image.

For example, in FIG. 5A, the highest frequency luminance value in the histogram for the R value is “195”, the highest frequency luminance value in the histogram for the B value is “191”, and the highest frequency luminance value in the histogram for the G value is “187”. Hence, the values “195”, “191”, and “187” are determined to be the luminance value of the R value, the luminance value of the G value, the luminance value of the B value of the pixel, respectively, of the pixel position (corresponding pixel position) corresponding to the pixel position 360 in the background image.

In addition, for example, in FIG. 5B, the highest frequency luminance value in the histogram for the R value is “98”, the highest frequency luminance value in the histogram for the B value is “91”, and the highest frequency luminance value in the histogram for the G value is “57”. Hence, the values “98”, “91”, and “57” are determined to be the luminance value of the R value, the luminance value of the G value, the luminance value of the B value of the pixel, respectively, of the pixel position (corresponding pixel position) corresponding to the pixel position 370 in the background image.

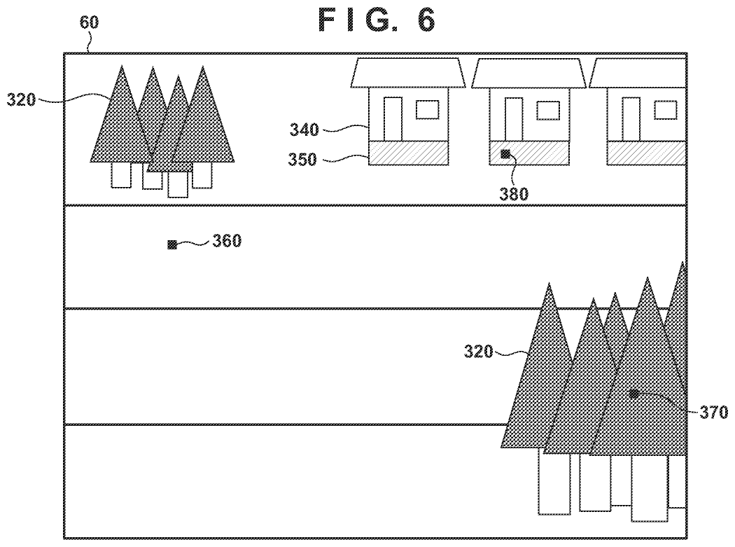

FIG. 6 shows an example of the background image generated, from the captured images capturing the scene of FIG. 3, by the above-described processing. When a background image 60 shown in FIG. 6 is compared to the scene of FIG. 3, it can be seen that the cars and the people have disappeared and only elements present in the scene as background elements, such as the road, the sidewalk, the trees, and the buildings, and the like, remain in the background image 60 shown in FIG. 6. However, in regards to the trees 320 in the background image 60, since the frequency value variation is large and the luminance value selected from the histogram for each pixel varies as shown in FIG. 5B, the trees 320 in the background image 60 will be blurry compared to the trees 320 in the captured image 30 of FIG. 3. In contrast, a large difference will not be generated, for example, in a vegetation region such as a target vegetation region in front of a distant building such as each lawn 350 in the captured image 30 and each lawn 350 in the background image 60. The background analysis unit 214 will store, in the storage unit 222, the background image generated in this manner.

A method of obtaining the amount of movement for each pixel in a background image will be described next. A method for obtaining the amount of movement in each pixel position (x, y) in the background image will be described below. By applying this method to each pixel position in the background image, the amount of movement in each pixel position in the background image can be obtained.

The amount of movement in the pixel position (x, y) in the background image can be a reciprocal of the width of a peak that includes the highest frequency in the histogram generated for the pixel position (x, y) or a reciprocal of the ratio of the total frequency (the total number of frequencies, which is 18,000 in this case) of the total value of the highest frequency and the frequencies distributed in its periphery. The latter method will be used here to describe the method of obtaining the amount of movement in the pixel position (x, y) in the background image.

First, the total value of the highest frequency in the histogram generated for the pixel position (x, y) in the background image and the respective frequencies of two luminance values adjacent to luminance value corresponding to the highest frequency in the histogram is obtained as “the width of the peak”. Subsequently, the background analysis unit 214 obtains the ratio of “the width of the peak” to the total frequency of “18,000”, and the reciprocal of the obtained ratio is obtained as the amount of movement in the pixel position (x, y) in the background image. Since the object that requires attention here is the obtainment of the amount of movement in the background by excluding the movement of the foreground, for example, the influence of the variation spreading in a low luminance value of FIG. 5A needs to be removed.

For example, in a case in which the amount of movement in a pixel position corresponding to the pixel position 360 in the background image is to be obtained, first, the width of the peak of each of the R, G, and B values will be obtained with reference to the histogram of FIG. 5A, and the ratio of each obtained width of peak to the total frequency “18,000” will be obtained.

In regards to the R value, since the highest frequency is “3,544” and the frequencies corresponding to the luminance values adjacent to the luminance value corresponding to the highest frequency are “1,532” and “0”, the width of the peak will be the total value “5,076” (=3,544+1,532+0) of these values. Hence, the ratio of “the width of the peak” to the total frequency “18,000” will be 5,076/18,000=0.282.

In regards to the G value, since the highest frequency is “4,898” and the frequencies corresponding to the luminance values adjacent to the luminance value corresponding to the highest frequency are “2,761” and “0”, the width of the peak will be the total value “7,659” (=4,898+2,761+0) of these values. Hence, the ratio of “the width of the peak” to the total frequency “18,000” will be 7,659/18,000=0.426.

In regards to the B value, since the highest frequency is “4,055” and the frequencies corresponding to the luminance values adjacent to the luminance value corresponding to the highest frequency' are “3,573” and “0”, the width of the peak will be the total value “7,628” (=4,055+3,573+0) of these values. Hence, the ratio of “the width of the peak” to the total frequency “18,000” will be 7,628/18,000=0.424.

The amount of movement can be obtained for each of the R, G, and B values of one pixel position or a single amount of movement can be obtained for one pixel position. The latter method will be employed here. Hence, in this case, the average value “0.377” (=(0.282+0.426+0.421)/3) of the ratios obtained for the respective R, G, and B values will be obtained, and a reciprocal “2.65” of this average value will be obtained as “the amount of movement in the pixel position corresponding to the pixel position 360 in the background image”.

In addition, for example, in a case in which the amount of movement in a pixel position corresponding to the pixel position 370 in the background image is to be obtained, first, the width of the peak of each of the R, G, and B values will be obtained with reference to the histogram of FIG. 5B, and the ratio of each obtained width of peak to the total frequency “18,000” will be obtained.

In regards to the R value, since the highest frequency is “693” and the frequencies corresponding to the luminance values adjacent to the luminance value corresponding to the highest frequency are “512” and “334”, the width of the peak will be the total value “1,539” (=693+512+334) of these values. Hence, the ratio of “the width of the peak” to the total frequency “18,000” will be 1,539/18,000=0.086.

In regards to the G value, since the highest frequency is “727” and the frequencies corresponding to the luminance values adjacent to the luminance value corresponding to the highest frequency are “631” and “540”, the width of the peak will be the total value “1,898” (=727+631+540) of these values. Hence, the ratio of “the width of the peak” to the total frequency “18,000” will be 1,898/18,000=0.105.

In regards to the B value, since the highest frequency is “1,020” and the frequencies corresponding to the luminance values adjacent to the luminance value corresponding to the highest frequency are “816” and “511”, the width of the peak will be the total value “2,347” (=1,020+816+511) of these values. Hence, the ratio of “the width of the peak” to the total frequency “18,000” will be 2,347/18,000=0.130.

The average value “0.107” (=(0.086+0.105+0.130)/3) of the ratios obtained for the respective R, G, and B values will be obtained, and a reciprocal “9.35” of this average value will be obtained as “the amount of movement in the pixel position corresponding to the pixel position 370 in the background image”.

As described above, since most of the movement will be increasingly distributed around the highest frequency as the size of movement decreases, the above-described ratio will increase. Hence, based on such a relationship, the reciprocal of the average value of the ratios is set as the amount of movement in this embodiment.

Note that the method of obtaining the amount of movement from the histogram described above is merely an example, and the method is not limited to this. For example, the total value of the highest frequency and the frequencies of luminance values adjacent to the luminance value corresponding to the highest frequency is obtained in the above-described embodiment. However, as the width of the peak increases, the height of the peak will be averaged out with the surroundings even in a case in which the movement is small. Hence, to prevent such an influence, the reciprocal of the ratio of the highest frequency to the total frequency may be set as the amount of movement. Alternatively, the total value of the highest frequency and the higher frequency among the frequencies of the luminance, values adjacent to the luminance value corresponding to the highest frequency may be obtained as the total value described above. Note that “neighboring luminance values” may be used instead of “the adjacent luminance values”.

Next, in step S440, the background image for each object region is segmented by the background analysis unit 214 by executing semantic segmentation processing (segmentation) to the background image generated in step S430. Note that in this embodiment, “a region of vegetation (vegetation region)” among the segmented regions obtained by the region-based segmentation executed in step S440 will be set as the specific region, and segmented regions other than the “vegetation region” will be set as non-specific regions. However, the attributes of the specific region and the non-specific region are not limited to the “vegetation region” and a “segmented region other than the vegetation region”, respectively.

Although a plurality of methods are known as segmentation methods, DeepLab (Google) which is a method based on machine learning, particularly, deep learning will be used here. To construct a discriminator to obtain regions corresponding to the road, the sky, the trees, and buildings by using DeepLab, frame images in which the road and the buildings appear are collected as training data from the moving image. More specifically, regions of the road and the buildings are extracted from each frame image in the moving image to generate a file in which the labels (of the road and the buildings) are written. By executing training using the training data prepared in this manner, a discriminator that can segment the regions of the road and the buildings can be constructed.

Next, in step S450, the background image generated in step S430 is segmented into a plurality of unit regions by the background analysis unit 214. The background analysis unit 214 subsequently sets a Qp value to each unit region in the background image. Since a Qp value will be set based on a unit of 16×16 pixels as a macroblock in H.264, a Qp value will be set for each macroblock (that is, a unit region=a macroblock will be set) in this embodiment. However, if a macroblock could be segmented even smaller, a Qp value may be set based on a smaller unit. Furthermore, since a Qp value can be set on a CTU basis in H.265, the setting can be performed in accordance with the size of the unit region to which a Qp value can be set.

If even a single pixel among the pixels forming a macroblock belongs to a non-specific region of the segmented regions obtained by the region-based segmentation executed in step S440, the background analysis unit 214 will determine that this macroblock belongs to a non-specific region. The background analysis unit 214 will set a value of “36” which is the Qp value for the non-specific region to the macroblock determined to belong to the non-specific region.

On the other hand, if all of the pixels forming a macroblock belong to a specific region of the segmented regions obtained by the region-based segmentation executed in step S440, the background analysis unit 214 will determine that this macroblock belongs to a specific region. The background analysis unit 214 will set a value of “40”, which is the Qp value for the specific region, to the Qp value controlled based on the amount of movement of each pixel forming the macroblock determined to belong to the specific region. For example, for a macroblock in which all of the pixels belong to a specific region, the background analysis unit 214 will obtain an average value Av of the amounts of movement corresponding to pixels forming the macroblock, and set the Qp value to be set to the macroblock to be “40+Av”.

For example, since the average value of the amounts of movement in a macroblock formed by pixels (the pixel in the pixel position 370 of FIG. 3 and the like) that have a histogram as shown in FIG. 5B will be not more than 8, a Qp value of “48” will be set to the macroblock by adding 8 as the amount of movement to “40” as the Qp value of the specific region. In a similar manner, even if the region is a vegetation region, since the amount of movement will be not more than 3 in a macroblock formed by a pixel in a pixel position 380 present in a lawn region in front of a building, a Qp value of “43” will be set to the macroblock by adding 3 as the amount of movement to “40” as the Qp value of the specific region.

Note that the Qp value “40” may also be added to a weighted average value of the amounts of movement. More specifically, by setting γ to be a weighting coefficient, the Qp value to be set to a vegetation region in the periphery of the pixel position 370 of FIG. 3 may be “40+8γ”, and the Qp value to be set to a vegetation region in the periphery of the pixel position 380 of FIG. 3 may be “40+3γ”. The size of the weighting coefficient γ may be 1 or may be, in a case in which greater compression needs to be executed on a region with movement, greater than 1. Furthermore, although only a vegetation region is set as the specific region in this embodiment, a plurality of different specific regions may also be selected and set with different weights. More specifically, with respect to the fact that the weighting coefficient γ of a vegetation region is 1, a case in which a water surface region is set as a specific region and the amount of movement in a water surface region is considered by further setting the weighting coefficient γ of a water surface region to be 1.5 may be considered. However, the Qp value can be set only on an integer basis. Hence, for example, if the weighting coefficient γ is 1.5 and a Qp value of 40+3γ=44.5 is obtained, processing such as rounding off or the like is performed to set an integer value as the Qp value. In such a case, 45 will be set here as the Qp value.

In this manner, by setting a greater Qp value in a location with greater movement even in the same vegetation region, it will be possible to degrade the image quality of a movement region in the background that does not include important information but can increase the bit rate due to low compression efficiency. As a result, the bit rate can be reduced. Subsequently, the background analysis unit 211 will store, in the storage unit 222, the Qp value of each macroblock in the background image.

### Compression Stage Processing

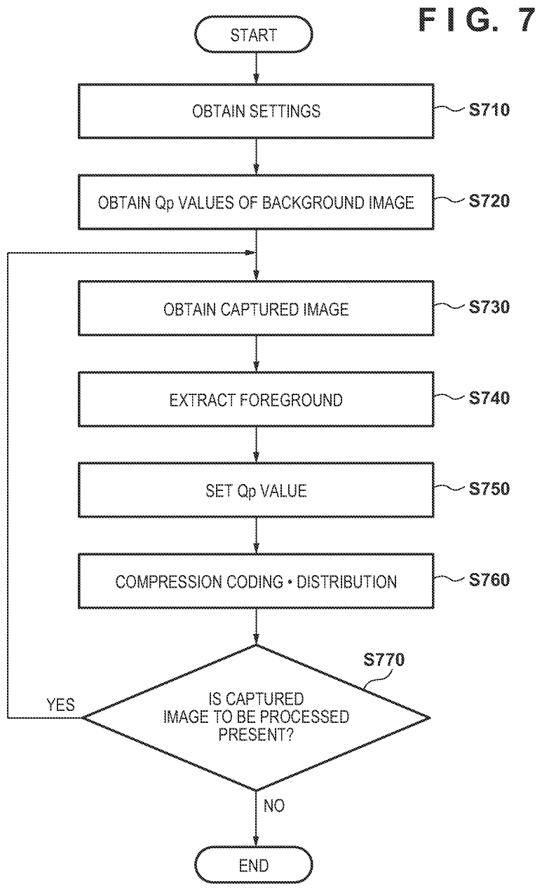

Next, the processing performed by the image processing apparatus 100 in the compression stage will be described in accordance with the flowchart of FIG. 7. In step S710, the image obtainment unit 211 obtains, in a manner similar to the process of the above-described step S410, the settings necessary for analyzing the moving image. In addition, the compression coding unit 212 obtains the compression coding parameters from the storage unit 222. The compression coding parameters obtained in this step include the Qp value for (assume that the value is “32” in this case) an ROI (foreground region).

In step S720, the control unit 223 obtains, from the storage unit 222, the respective Qp values of the macroblocks in the background image which were obtained by the processing in accordance with the flowchart of FIG. 4. In step S730, in a manner similar to the process of the above-described step S420, the image obtainment unit 211 generates, from the moving image captured by the image capturing unit 221, captured images of continuous frames in accordance with the various kinds of settings obtained in step S710.

In step S740, the foreground extraction unit 215 extracts the foreground (foreground region) to be the detection target from each captured image obtained in step S730. The scene of the road shown in FIG. 3 will be assumed here, and the cars and the people are set as the detection targets. Note that the extraction of the foreground may be performed on a captured image of each frame or may be performed on a captured image at an interval of several frames.

As a method of detecting a car or a person by image analysis, a method based on machine learning, particularly, deep learning, is known as a method that can achieve high accuracy and high speed processing that can support real time processing. More specifically, methods such as YOLO (You Only Lock Once), SSD (Single Shot Multibox Detector), and the like can be used. A case that uses SSD will be illustrated here. SSD is a method for detecting each object from an image that includes a plurality of objects.

To construct a discriminator that uses SSD to detect a car or a person from an image, training data is prepared by collecting each image that includes a car or a person from a plurality of images. More specifically, each person region and each car region are extracted from each image, and a file in which the coordinates of the center position and the size of each region are written is created. A discriminator that can detect a car or a person from an image is constructed by performing training by using the training data prepared in this manner.

Upon detecting a car or a person from a captured image by using the discriminator that has been generated in this manner, the foreground extraction unit 215 outputs the position and the size (the width and the height) of the detected car region or person region (foreground region) to the compression coding unit 212. The position of each foreground region is set at the center position of the foreground region in a coordinate system in which an upper left position of a captured image is set as the origin. Also, the size of the foreground region is the ratio of the foreground region (the width and the height) to the size of the captured image (the width and the height). The position and the size of each foreground region obtained in this manner will be output to the compression coding unit 212 in a list since a plurality of cars and persons may be detected in a captured image.

In step S750, the compression coding unit 212 specifies each correspondence region on the background image corresponding to a “foreground region on the captured image” which is specified based on “the position and the size of the foreground region” output from the foreground extraction unit 215 in step S740. Subsequently, the compression coding unit 212 specifies, among the macroblocks in the background image, a macroblock that is partially or entirely included in the correspondence region, and changes the setting so that the Qp value “32” for an ROI will be used instead of the Qp value of the specified macroblock.

In step S760, the captured image is segmented into a plurality of macroblocks by the compression coding unit 212, and compression coding of each segmented macroblock is performed by using the Qp value of the macroblock in the background image corresponding to the segmented macroblock. Subsequently, the compression coding unit 213 controls the communication unit 224 to distribute the captured image, in which all of the macroblocks have been compression-coded, to the client apparatus 200 via the network 300. Note that the distribution destination of the communication unit 224 is not limited to a specific destination. For example, the communication unit 224 may distribute the compression-coded captured image to another apparatus in addition to or instead of the client apparatus 200, or may store the compression-coded captured image in its own storage unit 222.

In step S770, the control unit 223 determines whether to continue executing the compression coding operation (whether a captured image to be processed is present). If it is determined that the processing is to be continued, the process advances to step S730. Otherwise, the processing according to the flowchart of FIG. 7 ends.

In this manner, in this embodiment, a Qp value is set to the background based on a background image and each amount of movement in the background that have been generated and extracted by analyzing captured images of frames corresponding to a predetermined time. As a result, compression coding can be performed at a high compression rate on a region, such as vegetation with constant movement or the like, in which the bit rate can increase but important information is not included. Furthermore, according to this embodiment, compression coding of an ROI of a captured image can be performed by using a Qp value for the ROI, and compression coding of a region in which the ROI has been excluded can be performed by using a Qp value set to a correspondence region which corresponds to the region in the background image. Hence, the image quality of the foreground can be increased preferentially in a case in which a target passes the front of a vegetation region, and the image quality of the vegetation region can be decreased as a background in a case in which a target does not pass in front of the vegetation region. As a result, the bit rate can be reduced more effectively.

### Timing of Background Analysis Processing and Foreground Extraction Processing

In this embodiment, the number of frames to be used for the background analysis by the background analysis unit 214 and a target time (that is, whether to thin or use all of the 30 fps) and the timing at which the background information (the background image and the amount of movement for each pixel in the background image) is updated become important.

The time to be taken for the background analysis needs to be changed in accordance with the use case. For example, the semantics of the movement to be extracted in the background will differ between a case in which the background information is updated once a month by executing a background analysis on a moving image equivalent to a day's worth of image capturing and a case in which the background information is updated every few minutes by executing a background analysis on a moving image of approximately few GOPs (Groups of Pictures). This embodiment assumes a use case that targets monitoring of a general road as shown in FIG. 3. In this use case, in the case of the former, the distribution of trees with frequent movement and the distribution of lawns without much movement will be extracted, and the background information will be updated when the state of the trees changes in accordance with the season. In contrast, in the case of the latter, the change in the movement of the trees in correspondence to the strength of the wind can be reflected, but cars and persons waiting for a traffic light to change can also be processed as the background because the scale of the time used for the analysis is short. The background analysis using a moving image of about 10 minutes shown in this embodiment is a background analysis of a time in which cars and persons waiting for the traffic light to change will not be recognized as part of the background. Also, in a case in which the background information is to be updated every hour, the change in the strength of the wind due to the change in the weather can be reflected. If a region to be designated as a specific region is set not to a vegetation region but to a water surface or the like, the updating of the background information can be applied to a sea surface, a surface of a lake, or the like at a similar timing.

### Second Embodiment

In each embodiment including this embodiment hereinafter, differences from the first embodiment will be described. Assume that various kinds of arrangements are similar to those of the first embodiment unless particularly mentioned below. The control of compression coding includes not only control by designating Qp values, but also control by using a CBR (Constant Bit Rate). Control by CBR is control performed to maintain a constant bit rate by changing the Qp values in accordance with the moving image. Although the control by CBR is advantageous in that the capacity for recording a moving image can be controlled, negative effects such as a large degradation in the image quality may occur depending on the contents of the moving image. Also, it is also possible to assume a case in which the image quality of a main object will change, even if the same scene is captured, due to the fact that the Qp value to be set will differ between a day in which trees sway greatly due to a strong wind and a day in which the trees do not sway. In order to prevent such a state, the bit rate will be controlled by selectively reducing the image quality of a region with large movement in this embodiment.

### Analysis Stage Processing

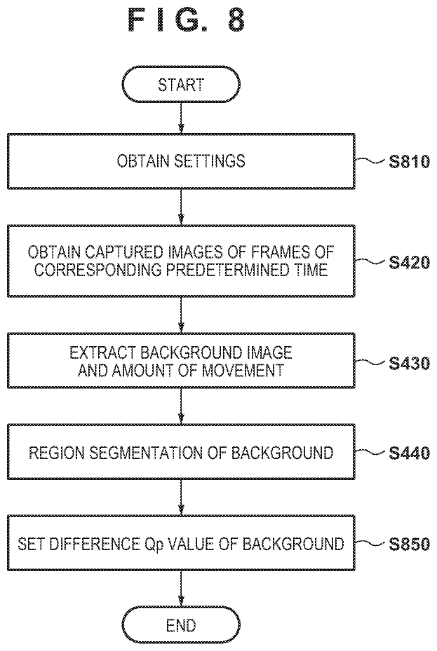

Processing performed by an image processing apparatus 100 in an analysis stage will described in accordance with the flowchart of FIG. 8. Note that in the flowchart of FIG. 8, the same step numbers denote processing steps similar to the processing steps shown in FIG. 4, and a description of such processing steps will be omitted.

In step S810, in addition to the settings obtained in the process of step S410, an image obtainment unit 211 obtains, with respect to the Qp values to be used when encoding is to be performed in compliance with H.264, a difference between a Qp value for a general background and a Qp value for an ROI and a difference between a Qp value for a specific region and the Qp value for the ROI.

In this case, “4” is obtained as the difference (to be referred to as “Δ general background Qp value” hereinafter) between the Qp value for the general background and the Qp value for the ROI, and “8” is obtained as the difference (to be referred to as “Δ specific region Qp value”) between the Qp value for the specific region and the Qp value for the ROI.

Next, in step S850, the background image generated in the process of step S430 is segmented into a plurality of unit regions by a foreground extraction unit 215. The foreground extraction unit 215 subsequently sets a difference Qp value to each of the unit regions in the background image. A difference Qp value will be set for each macroblock in this embodiment as well.

If even a single pixel among the pixels forming a macroblock belongs to a non-specific region of the segmented regions obtained by the region-based segmentation executed in step S440, the foreground extraction unit 215 will determine that this macroblock belongs to a non-specific region. Subsequently, the foreground extraction unit 215 will set, to the macroblock determined to belong to the non-specific region, a difference Qp value=α×Δgeneral background Qp value as the compression coding parameter. In this case, α represents a weighting coefficient.

If all of the pixels forming a macroblock belong to a specific region of the segmented regions obtained by the region-based segmentation executed in step S440, the foreground extraction unit 215 will determine that this macroblock belongs to a specific region. Subsequently, the foreground extraction unit 215 will set, to the macroblock determined to belong to the specific region, a difference Qp value=β×Δspecific region Qp value+γ×v as the compression coding parameter. In this case, β and γ are weighting coefficients (γ is as described above) and v is an average value of the amounts of movement corresponding to pixels forming the macroblock. The foreground extraction unit 215 will store, in a storage unit 222, the difference Qp value set for each macroblock in the background image.

### Compression Stage Processing

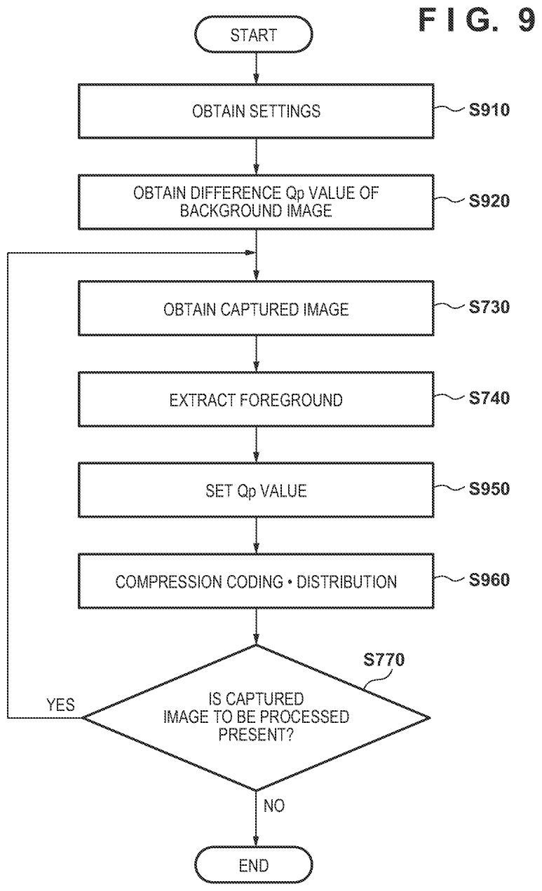

Next, the processing performed by the image processing apparatus 100 in the compression stage will be described in accordance with the flowchart of FIG. 9. Note that in the flowchart of FIG. 9, the same step numbers denote processing steps similar to the processing steps shown FIG. 7, and a description of such processing steps will be omitted.

In step S910, the image obtainment unit 211 obtains, in a manner similar to the process of the above-described step S410, the settings necessary for analyzing the moving image. In addition, a compression coding unit 212 obtains the compression coding parameters from the storage unit 222. The compression coding parameters obtained in this step include the Qp value for (assume that the value is “32” in this case) the ROI, an initial value (assume that the value is “38” in this ease) of CBR of the Qp value for the ROI, and “2 Mbps” as the target bit rate of the CBR.

In step S920, a control unit 223 obtains, from the storage unit 222, the difference Qp value of each macroblock in the background image obtained by the processing in accordance with the flowchart of FIG. 8.

Next, in step S950, the compression coding unit 212 sets the corresponding Qp value to each of the ROI, the specific region, and the non-specific region in the captured image. Although a plurality of methods are known for controlling the bit rate, the simplest control method will be employed here. That is, in the control method to be employed, compression coding will be performed by setting an initial Qp value, and the Qp value will be increased if the bit rate is higher than expected and decreased if the bit rate is lower than expected. A Qp value for a comparatively low image quality will be set as the initial Qp value to prevent a state in which the distribution and storage will be suppressed due the occurrence of an unexpectedly extremely high bit rate. As an example, the compression coding unit 212 will set the following Qp values as the respective Qp values of the ROI, the specific region, and the non-specific region in the background image.

Qp value for the ROI=R

Qp value for the specific region=R+(β×Δspecific region Qp value+γ×v)

Qp value for the non-specific region=R+(α×Δgeneral background Qp value)

Here, the term “(β×Δ specific region Qp value+γ×v)” of the Qp value for the specific region is the difference Qp value set to the macroblock in the background image that corresponds to the macroblock in the specific region. Also, the term “(α×Δ general background Qp value)” the Qp value for the non-specific region is the difference Qp value set to the macroblock in the background image that corresponds to the macroblock in the non-specific region.

Let “38” be the initial value of R, and “1” be the initial value of each of α, β, and γ. In this case, the Qp value for the ROI, the Qp value for the specific region, and the Qp value for the non-specific region will be as follows respectively.

Qp value for the ROI=38

Qp value for the specific region=38+(8×β+v)

Qp value for the non-specific region=38+(4×α)

Next, in step S960, the compression coding unit 212 uses the Qp value for the ROI, the Qp value for the specific region, and the Qp value for the non-specific region to perform compression coding of the background image. The compression coding of the ROI is performed by using the Qp value for the ROI, the compression coding of the specific region is performed by using the Qp value for the specific region, and the compression coding of the non-specific region is performed by using the Qp value for the non-specific region. Subsequently, the compression coding unit 212 reduces the value of R so as to bring the bit rate obtained as a result of the compression coding closer to the target bit rate. Hence, in the next compression coding processing, compression coding will be performed by using Qp values to which the reduced R value has been reflected.

For example, in a case in which the bit rate obtained as a result of the compression coding is lower than the target bit rate, the compression coding unit 212 will reduce the R value (that is, the R value will not be decreased any more if the R value has reached 32). Since it can be assumed that the first result of the compression coding will be smaller than the target bit rate, the R value will be reduced one by one from the initial value of 38 per processing. However, in a case in which the bit rate is half the target value or lower, the R value may be reduced by a value of 2 per processing.

Subsequently, if the current bit rate is still lower than the target bit rate even when the R value has reached 32, the compression coding unit 212 will reduce the image quality degradation of the background by reducing, while keeping the R value fixed to 32, the weighting coefficients α and β to reduce the difference between the Qp value for the ROI and the Qp values for specific region and the non-specific region.

If the current bit rate is still lower than the target bit rate even when the weighting coefficients α and β have reached 0. The compression coding unit 212 will reduce the weighting coefficient γ while keeping the R value fixed to 32 and the weighting coefficients α and β fixed to 0 (that is, the degree of contribution of the average value of the amounts of movement to the Qp values will be decreased). The method of reducing the weighting coefficients α, β, and γ is not limited to a particular method. For example, the weighting coefficient γ may be reduced if the weighting coefficients α and β become 0.5 or less or the weighting coefficients α, β, and γ may be simultaneously reduced based on a predetermined ratio (for example, α:β:γ=4:2:1).

In addition, in a case in which the current bit rate has become higher than the target bit rate before the R value has reached 32, the compression coding unit 212 execute adjustment by increasing the weighting coefficients α, β, and γ so that the current bit rate will become lower than the target bit rate even when the R value reaches 32. In this case, the weighting coefficient γ will be increased first. Subsequently, if the current bit rate is still higher than the target bit rate even when the weighting coefficient γ has been creased to 15, the weighting coefficient β will be increased, and then the weighting coefficient α will be increased last. There are a plurality of methods for adjusting of the weighting coefficients α, β, and γ, and the adjustment method may be changed in accordance with the use ease,

In this manner, according to this embodiment, the moving image can be distributed without reducing the image quality of the ROI when bit rate control is to be executed based on CBR. In this case, control can be performed by using different weights for a background with movement, a specific region such as such as a vegetation region, and a general background. In particular, the image quality of the background with movement will be reduced first, the image quality of the specific region such as the vegetation region will be reduced next, and the image quality of the general background will be reduced last. This will allow the image quality of a region with lesser amount of information where the bit rate can be increased more easily to be reduced first.

### Third Embodiment

In each of the above-described embodiments, Op value control based on a difference between an I-frame and a P-frame that characterizes moving image compression according to standards such as H.264 and H.265 has not been performed. Instead, control has been performed by setting common Qp values to both kinds of frames. However, compared to an I-frame in which compression is performed by using information within the frame, compression is performed only on a difference from a previous frame in the P-frame. Thus, the influence from a movement in the background will increase in the P-frame. Hence, compression coding will be performed by using a Qp value (a Qp value which is not dependent on the amount of movement) in which the weighting coefficient γ=0 in an I-frame captured image, and compression coding will be performed by using a Qp value (a value which is dependent on the amount of movement) in which the weighting coefficient γ is set in a manner similar to the above-described embodiments in a P-frame. Although the compression effect will decrease by making settings in this manner, the image quality of the moving image will greatly improve. This is because a target unit region (macroblock) will be skipped more easily when the Qp value set to the P-frame increases, and each value of the previous frame will be directly used. Therefore, although the change in the movement due to the swaying of the tress will not be reflected accurately, a moving image with a comparatively good image quality background can be obtained because each value of the I-frame that has been compressed in a comparatively high image quality will be directly used. Alternatively, a method for setting each P-frame to be skipped may be employed when there is a large amount of movement.

Executing such processing will allow a moving image in which the image quality has been maintained to be obtained by losing only unnecessary information such as the fine swaying of the trees or the like in a use case such as a scene of a park or the like with a large vegetation region.

### Fourth Embodiment

Although each of the above-described embodiments exemplified an arrangement in which an image processing apparatus 100 and a client apparatus 200 are connected via a network 300, the present disclosure is not limited to this, and the image processing apparatus 100 and the client apparatus 200 may be integrated.

In addition, each of the above-described embodiments described a case in which background analysis processing by a background analysis unit 214 and foreground extraction processing by a foreground extraction unit 215 are performed by the image processing apparatus 100 which includes an accelerator unit 225. However, in particular, in relation to the background analysis processing, the background analysis processing may be executed in a computer apparatus such as the client apparatus 200 or the like after the moving image has once been distributed or may be executed by an accelerator unit that has been added externally. Also, a moving image captured by the image processing apparatus 100 may be stored in a storage medium such as an SD card that has been inserted in the image processing apparatus 100, and the storage medium may be inserted into a computer apparatus, which is not connected to the network 300, to copy the moving image to the computer apparatus. As a result, the computer apparatus will be able to perform the background analysis processing, the foreground extraction processing, and the like, described above, on the moving image.

In addition, the numerical values, the processing timings, the processing orders, and the like used in the above description are merely examples that are used for the sake of a more specific explanation, and the present disclosure is not limited to these numerical values, processing timings, processing orders, and the like.

Furthermore, some or all of the above-described embodiments may be appropriately combined and used. Additionally, some or all of the above-described embodiments may be selectively used.

### Other Embodiments

The present disclosure can also be implemented by processing for supplying a program configured to implement at least one function of the above-described embodiments to a system or an apparatus via a network or a storage medium and causing at least one processor in the computer of the system or the apparatus to read out and execute the program. The present disclosure can also be implemented by a circuit (for example, ASIC) that implements the at least one function.

The present disclosure is not limited to the above embodiments and various changes and modifications can be made within the spirit and scope of the present disclosure. Therefore, to apprise the public of the scope of the present disclosure, the following claims are made.

According to the above-described embodiments, in a case in which different compression coding parameters are to be set for a specific region and a non-specific region in a background image to be used for compression coding, a technique for setting a compression coding parameter that corresponds to an amount of movement in the specific region can be provided.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-075607, filed Apr. 21, 2020, which is hereby incorporated by reference herein in its entire

What is claimed is:

1. An image processing apparatus comprising:
a determination unit configured to obtain a pixel value of the same pixel position from a plurality of images and determine, based on a frequency distribution of the obtained pixel value, the pixel value and an amount of movement in the pixel position in a background image; and
a setting unit configured to set a compression coding parameter to the background image,
wherein in a specific region in the background image, the setting unit sets a compression coding parameter corresponding to an amount of movement of a pixel belonging to the specific region.

2. The apparatus according to claim 1, wherein the determination unit obtains the pixel value of the same pixel position from the plurality of images, and determines, as the pixel value of the pixel position in the background image, a pixel value with a highest frequency in the frequency distribution of the obtained pixel value.

3. The apparatus according to claim 1, wherein the determination unit obtains the pixel value of the same pixel position from the plurality of images, obtains a total value of frequency corresponding to a pixel value with a highest frequency and frequency corresponding to a pixel value neighboring the pixel value with the highest frequency in the frequency distribution of the obtained pixel value, and determines, as the amount of movement in the pixel position in the background image, a reciprocal of a ratio of the total value to a total number of frequencies in the frequency distribution.

4. The apparatus according to claim 1, wherein the determination unit obtains the pixel value of the same pixel position from the plurality of images, and determines, as the amount of movement in the pixel position in the background image, a reciprocal of a ratio of a highest frequency in the frequency distribution of the obtained pixel value to a total number of frequencies in the frequency distribution.

5. The apparatus according to claim 1, wherein for a unit region which belongs to a specific region among a plurality of unit regions obtained by segmenting a background image, the setting unit sets a larger quantization parameter value as an average value of amounts of movement in pixels belonging to the unit region increases.

6. The apparatus according to claim 5, wherein the quantization parameter value to be set to the unit region which belongs to the specific region is a quantization parameter value based on a quantization parameter value for the specific region and an average value of the amounts of movement in the pixels belonging to the unit region.

7. The apparatus according to claim 5, wherein the quantization parameter value to be set to the unit region which belongs to the specific region is a quantization parameter value based on a difference, between a quantization parameter value for the specific region and a quantization parameter value for a foreground region, and an average value of the amounts of movement in the pixels belonging to the unit region.

8. The apparatus according to claim 1, further comprising:
an extraction unit configured to extract a foreground region from an image to be a target of compression coding; and
a compression coding unit configured to compression-code the foreground region by using a compression coding parameter for the foreground. region, and compression-code a region, which excludes the foreground region in the image, by using a compression coding parameter set to a correspondence region which corresponds to the region in the background image.

9. The apparatus according to claim 8, wherein in a case in which a bit rate of compression coding by the compression coding unit is lower than a target bit rate, the compression coding unit will control a first compression coding parameter for the foreground region, a second compression coding parameter for a region corresponding to the specific region in the background image in the image to be the target of compression coding, and a third compression coding parameter for a region corresponding to a non-specific region in the background image in the image to be the target of compression coding.

10. The apparatus according to claim 9, wherein in a case in which the bit rate of the compression coding by the compression coding unit is lower than the target bit rate, the compression coding unit executes control to reduce a difference between the first compression coding parameter and the second compression coding parameter and the third compression coding parameter.

11. The apparatus according to claim 9, wherein in a case in which the bit rate of the compression coding by the compression coding unit is lower than the target bit rate, the compression coding unit executes control to reduce a degree of contribution of the amount of movement in a pixel belonging to the specific region to the second compression coding parameter.

12. The apparatus according to claim 8, wherein in a case in which the image to be the target of the compression coding is an I-frame, the compression coding unit will use a compression coding parameter, which does not depend on the amount of movement in the pixel belonging to the specific region, to perform compression coding of a correspondence region corresponding to the specific region in the image, and
in a case in which the image to be the target of compression coding is a P-frame, the compression coding unit will use a compression coding parameter, which depends on the amount of movement in the pixel belonging to the specific region, to perform compression coding of the correspondence region corresponding to the specific region in the image.

13. The apparatus according to claim 8, further comprising:
a distribution unit configured to distribute a result of the compression coding by the compression coding unit.

14. The apparatus according to claim 8, further comprising:
an image capturing unit,
wherein the plurality of images and the image to be the target of compression coding are images captured by the image capturing unit.

15. An image processing method performed by an image processing apparatus, comprising:
obtaining a pixel value of the same pixel position from a plurality of images, and determining, based on a frequency distribution of the obtained pixel value, the pixel value and an amount of movement in the pixel position in a background image; and
setting a compression coding parameter to the background image,
wherein in a specific region in the background image, a compression coding parameter corresponding to an amount of movement of a pixel belonging to the specific region is set in the setting.

16. A non-transitory computer-readable storage medium storing a computer program for causing a computer to function as
a determination unit configured to obtain a pixel value of the same pixel position from a plurality of images and determine, based on a frequency distribution of the obtained pixel value, the pixel value and an amount of movement in the pixel position in a background image; and
a setting unit configured to set a compression coding parameter to the background image,
wherein in a specific region in the background image, the setting unit sets a compression coding parameter corresponding to an amount of movement of a pixel belonging to the specific region.
